(19) United States
(12) Patent Application Publication
(10) Pub. No.: US 2025/0125502 A1
(43) Pub. Date: Apr. 17, 2025

(54) Method for Manufacturing an Individual Battery Cell

(71) Applicant: Mercedes-Benz Group AG, Stuttgart (DE)

(72) Inventors: Hendrik DUBBE, Stuttgart (DE); Malte Henrik KLEIN, Stuttgart (DE)

(21) Appl. No.: 18/694,316

(22) PCT Filed: Jun. 29, 2023
(86) PCT No.: PCT/EP2023/067890

§ 371 Date: Mar. 21, 2024

(30) Foreign Application Priority Data
Jul. 4, 2022 (DE) 10 2022 002 419.5

(51) Int. Cl. H01M 50/536; B23K 20/10; B23K 101/36; H01M 50/169

(52) U.S. Cl. CPC H01M 50/536; H01M 50/169; B23K 20/10; B23K 2101/36

(57) ABSTRACT

A method for producing an individual battery cell having a stack of electrodes and separators respectively disposed between the electrodes where the electrodes have respective conductor lugs which protrude laterally beyond the stack. The method includes compacting the conductor lugs and connecting the compacted conductor lugs on a side facing the stack by welding. The method further includes gripping the compacted and connected conductor lugs on a side facing away from the stack by a welding electrode and coiling the compacted and connected conductor lugs around the welding electrode in a direction of the stack to create a roll. A cell lid of the individual battery cell is welded to the roll.

### BACKGROUND AND SUMMARY OF THE INVENTION

The invention relates to a method for manufacturing an individual battery cell of the kind herein.

Individual battery cells, for example in lithium-ion technologies, are known in principle from the prior art. They consist substantially of a housing, and electrochemically active materials arranged in this housing. Typically, these individual battery cells are a stack, or sometimes a coil of cathodes, anodes and separators, which are installed in the housing and submerged in electrolyte. The housing is then sealed.

The electrodes are typically contacted via conductor lugs protruding beyond the stack or coil, wherein the conductor lugs of the cathode typically protrude on one side, and the conductor lugs of the anode typically protrude on the other side. Depending on the design of the housing, the conductor lugs of the anodes can for example be welded to one another, and those of cathode can be pressed against a metallic, conductive housing or similar. Naturally, this can also be implemented the other way around, or the two electrodes can be correspondingly welded.

It is known from the general prior art that during welding, the individual protruding conductor lugs are welded to a current collector, which is then welded to a cell lid, for example before the individual battery cell is sealed, during which the cell lid can in particular be welded to the housing. This is comparatively complex, requires several weld seams and a comparatively large amount of installation space due to the additional current collector in the individual battery cell. Each weld seam places a high thermal load on the electrochemistry of the cell, which is a disadvantage. The more material which has to be melted, the more critical this can be.

It is additionally known from DE 10 2015 209 719 B4 to weld the conductor lugs without a current collector. For this purpose, they are held down with a holding down device having an elastic element, and are directly welded to one another by an ultrasonic welding method. The conductor lugs of one electrode, which protrude on one side of the cell stack, and the conductor lugs of the other electrode, which protrude from the other side of the cell stack, can thus respectively be directly welded to one another, and to the corresponding stacks of neighbouring electrodes.

An electrode arrangement for a battery cell is known from US 2011/0206976A1. The conductor lugs of the individual electrodes are coiled together with a conductor of the individual battery cell, and respectively connected, e.g., welded, to an anode conductor or cathode conductor for all corresponding electrodes within the individual battery cell. The latter can then for example be removed isolated from the housing.

WO 2010/030606 A2 describes an electrochemical cell having at least one electrode. The end of each individual electrode film protruding beyond the active material is coiled in order to make it easier to contact all the electrodes of the individual battery cell that have the same polarity.

The object of the present invention is to specify a method for manufacturing a battery cell, which further simplifies the structure known from the prior art, and yet guarantees safe and reliable electrical contacting of the conductor lugs.

The method according to the invention provides that the conductor lugs are welded, as is known from the prior art. According to the invention, they are compacted for this purpose, and first attached by tack welding on their side facing the stack or coil by this welding, which, according to a very advantageous embodiment, can be in the form of ultrasonic welding, in order to prevent their position from changing within the stack or coil and individual electrodes or separators from being pulled out from the stack or coil during production. The conductor lugs attached thus via the ultrasonic tack welding are then gripped by a welding electrode on their end facing away from the stack or coil, and coiled around this welding electrode in the direction of the stack or coil. A cell lid of the individual battery cell is then welded to the coiled conductor lugs. The use of an additional current collector, to which the individual conductor lugs are welded, is thus not required here. Unlike in the prior art specified above, the conductor lugs attached by tack welding also do not remain unprocessed, because they are then very thin and vulnerable under mechanical load, and could rupture very quickly, which would massively compromise the electrical performance of the structure.

Instead, in the method according to the invention, the conductor lugs are coiled in the direction of the stack, specifically on a welding electrode located in the interior of this coil. The structure can be directly completed by the cell lid, and thus without an interposing current collector, by welding this cell lid to the rolled-up or coiled conductor films. The latter then form a coil welded to the cell lid, which results in a mechanically stable structure, which only partially conducts the heat which arises during welding to the stack or coil. In particular, a large part of the heat is dissipated through the welding electrode.

According to a further very favorable embodiment of the method according to the invention, it can be provided that the conductor films are gripped by means of a groove in the welding electrode. Such a groove can for example be provided in a square or round welding electrode. The latter is positioned on the stack of conductor lugs tack-welded together such that its end facing away from the stack or coil, which has been compacted during or after the attachment by tack welding, comes to rest in this groove. By twisting the welding electrode, this compacted stack of conductor lugs is now coiled around this welding electrode. According to a further very advantageous embodiment, the welding electrode is then removed from the coiled conductor films after the coiled conductor films are welded onto the cell lid, such that a roll which is hollow, but which is very stable per se because it is multi-layered, remains, the individual layers of which roll are welded to one another and to the cell lid on the side facing the cell lid in a linear manner along the central axis of the welding electrode.

This very stable structure, formed of a cell lid and a stack or coil, can then be very easily and efficiently handled, and installed in a housing, after which the cell lid is welded to the housing, preferably via laser welding.

Not only can the tack welding attachment of the conductor films be implemented by means of ultrasonic welding, but, according to a very advantageous embodiment of the method according to the invention, the welding of the coiled conductor films onto the cell lid or of the cell lid onto the coiled conductor films can also be implemented by means of ultrasonic welding. Only the welding of the lid to the housing can preferably be implemented more efficiently via laser welding.

A further, very favorable embodiment of the method for producing the individual battery cell according to the invention provides that the conductor films are attached by tack welding in the stacking direction or transversely to the coiling direction at an approximately central height. Thus, the conductor films are not, as is common practice today, collected on one side of the stack, and compacted and welded there, but rather combined in the centre, in order to tack them to one another as close as possible to the cell stack, with as small as possible a distance of the individual conductor films from the weld seam.

An individual battery cell produced according to the method according to the invention provides a stack or coil of cathodes, anodes and separators, which is arranged in a cell housing sealed with a cell lid. It is the case that the conductor lugs protrude from at least one of the electrodes beyond the stack or coil, and are rolled up in this region and welded to the cell lid. According to an advantageous development of the individual battery cell according to the invention, the cell lid can in turn be welded to the housing.

Advantageous embodiments and developments of the method according to the invention and of the individual battery cell produced by the method also result from the exemplary embodiment, which is described in more detail in the following with reference to the figures.

### BRIEF DESCRIPTION OF THE DRAWINGS

FIG. 1 shows the production of an individual battery cell in a first method step with a schematically indicated cell stack;

FIG. 2 shows a depiction analogous to that of FIG. 1 in a second method step;

FIG. 3 shows a depiction analogous to that of FIG. 1 and FIG. 2 in a third method step; and

FIG. 4 shows the completion of the individual battery cell in a final method step.

### DETAILED DESCRIPTION OF THE DRAWINGS

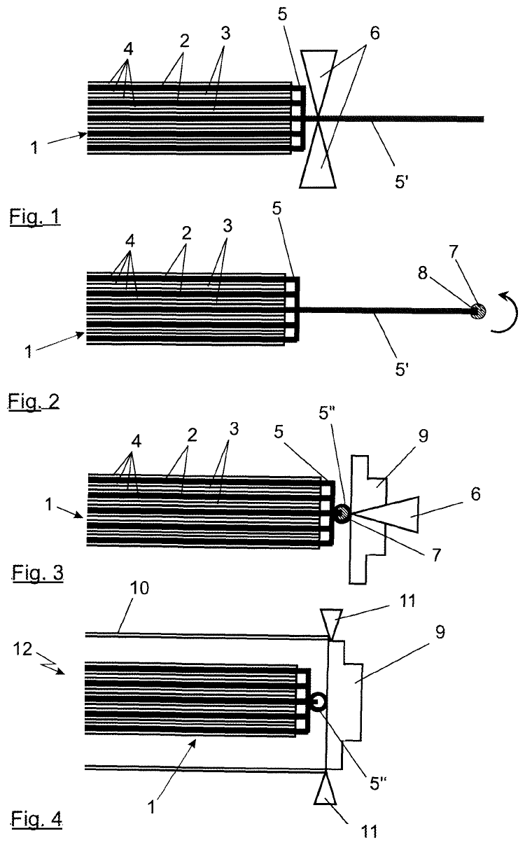

In the depiction of FIG. 1, a section of a stack 1 can be seen. This stack 1 consists of different electrodes 2, 3, i.e., the anodes and the cathodes. Separators 4 are respectively arranged in between. In the exemplary embodiment depicted here, the cathodes are supported on an aluminium foil, which is here depicted with a thick, solid, black line. The ends of these cathodes 2 protrude transverse to the stacking direction laterally beyond the stack 1 as conductor lugs 5. They are grouped together in this region, with only five individual cathodes 2 being depicted in the figure in order to correspondingly simplify the depiction. The conductor lugs 5 are grouped together centrally in relation to the height of the stack 1 in the stacking direction, and are compacted in the region labelled 5′. On the side of these compacted conductor lugs 5 facing the stack 1, a weld seam or individual spot welds is or are placed along the width of the stack 1 extending into the depth of the page in the depiction of FIG. 1 by means of an ultrasonic welding device 6, in order to connect the compacted conductor lugs 5′ and to reliably prevent the electrodes 2, 3 or separators 4 from being pulled out of the stack 1 over the further course of the method.

The end of the compacted conductor lugs 5′ facing away from the stack 1 is now gripped by a welding electrode 7, which is for example designed as a rod-shaped electrode having a groove 8, by introduction of the compacted conductor lugs 5′ into this groove. The welding electrode 7 is then coiled in the direction of the stack 1 according to the arrow in FIG. 2, such that a roll 5″ composed of several layers of the compacted conductor lugs 5′ running in a spiral shape is created. This roll 5″, having the welding electrode 7 arranged therein, is now brought into contact with a cell lid 9 and is welded to the cell lid through the material of this cell lid 9. This process too can in turn be implemented as ultrasonic welding, for which reason the symbolic depiction of the welding is labelled with the reference sign 6 in turn. The coiled conductor lugs, which are here labelled 5″ after they are coiled to form the roll, form a very compact structure which can efficiently and reliably easily be welded to the cell lid 9.

The welding electrode 7 is then pulled out laterally and a very robust structure formed of the stack 1 and the cell lid 9 is created, which can then for example be installed in a housing already filled with electrolyte, or in such a housing 10 after the stack 1 is submerged, as can be seen in the depiction of FIG. 4. The structure is also depicted purely schematically here; typically the cell stack will of course take up more space within the housing. The cell lid 9 can then for example be welded to the housing 10 by laser welding, which is here correspondingly indicated by the two triangles 11.

In principle, the method described and the individual battery cell 12 which can be obtained according to this method, which individual battery cell can be seen sectionally in the depiction of FIG. 4, can be used correspondingly for both a round and a prismatic housing 10. In particular, it is suitable for electrically contacting a stack 1 with the cell lid, and thus preferably for a structure with a prismatic housing 10.

Compared to the prior art, material and production complexity and costs are saved here, because the additional welding to the current collector, as is known from the general prior art, is not required. The proven concept of independent individual battery cells 12, which are then externally electrically contacted, is simultaneously retained, which offers considerable advantages with regard to scalability and security that cannot be implemented in this way in the aforementioned prior art.

In the depictions of the figures, only parts of the stack 1 or of the individual battery cell 12 can respectively be seen. The missing side can be designed identically, or in any other way known per se. This relates both to the housing and to the contacting of the respective other electrode 3, i.e., the anode in this case.

1-8. (canceled)

9. A method for producing an individual battery cell (12) having a stack (1) of electrodes (2, 3) and separators (4) respectively disposed between the electrodes (2, 3), wherein the electrodes (2, 3) have respective conductor lugs (5) which protrude laterally beyond the stack (1), comprising the steps of:
compacting the conductor lugs (5) and connecting the compacted conductor lugs (5′) on a side facing the stack (1) by welding;
gripping the compacted and connected conductor lugs (5′) on a side facing away from the stack (1) by a welding electrode (7) and coiling the compacted and connected conductor lugs (5′) around the welding electrode (7) in a direction of the stack (1) to create a roll (5″); and
welding a cell lid (9) of the individual battery cell (12) to the roll (5″).

10. The method according to claim 9, wherein the compacted and connected conductor lugs (5′) are gripped by a groove (8) in the welding electrode (7).

11. The method according to claim 9, further comprising the step of removing the welding electrode (7) from the roll (5″) after cell lid (9) is welded to the roll (5″).

12. The method according to claim 9, further comprising the step of installing the roll (5″) with the welded-on cell lid (9) in a housing (10) and, after the installing, welding the cell lid (9) to the housing (10).

13. The method according to claim 12, wherein the cell lid (9) is laser welded to the housing (10).

14. The method according to claim 9, wherein the compacted and connected conductor lugs (5′) are welded by ultrasonic welding.

15. The method according to claim 9, wherein the cell lid (9) is welded to the housing (10) by ultrasonic welding.

16. The method according to claim 9, wherein the compacted conductor lugs (5′) on the side facing the stack (1) are connected by tack welding in a stacking direction at a central height.

17. The method according to claim 9, wherein the electrodes (2, 3) are cathodes (2).

18. The method according to claim 9, wherein the electrodes (2, 3) are anodes (3).
